(19) United States
(12) Patent Application Publication
(10) Pub. No.: US 2019/0166175 A1
(43) Pub. Date: May 30, 2019

(54) SYSTEMS AND METHODS FOR DETERMINING VALUES FOR USER PERMISSION IN A MIXED REALITY ENVIRONMENT

(71) Applicant: Tsunami VR, Inc., Del Mar, CA (US)

(72) Inventors: David ROSS, San Diego, CA (US); Beth BREWER, Escondido, CA (US); Kyle PENDERGRASS, San Diego, CA (US)

(21) Appl. No.: 16/206,530

(22) Filed: Nov. 30, 2018

Related U.S. Application Data
(60) Provisional application No. 62/593,058, filed on Nov. 30, 2017.

(51) Int. Cl. H04L 29/06; G06T 19/00; H04L 29/08

(52) U.S. Cl. CPC H04L 65/602; H04L 65/4053; H04L 67/303; G06T 19/003; H04L 65/80

(57) ABSTRACT

Systems, methods, and computer readable media for operating a digitally created collaborative environment including a plurality of user devices are provided. The method can include determining condition values experienced at a plurality of user devices coupled to a network. Each condition value can be associated with a condition of the associated user device. The method can include determining permission values for each user permission of a plurality of user permissions based on the condition values. Each user permission can indicate a mode of operation of the respective user device in conjunction with the collaborative environment. The method can include selecting a permission value of a user permission of the plurality of user permissions and applying the permission to the respective user device.

### CROSS REFERENCE TO RELATED APPLICATIONS

This application claims priority to U.S. Provisional Patent Application Ser. No. 62/593,058, filed Nov. 30, 2017, entitled “SYSTEMS AND METHODS FOR DETERMINING VALUES OF CONDITIONS EXPERIENCED BY A USER, AND USING THE VALUES OF THE CONDITIONS TO DETERMINE A VALUE OF A USER PERMISSION TO APPLY TO THE USER,” the contents of which are hereby incorporated by reference in their entirety.

### BACKGROUND

### Technical Field

This disclosure relates to virtual reality (VR), augmented reality (AR), and hybrid reality technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics. As virtual objects become more complex by integrating more features, encoding and transferring all features of a virtual object between applications becomes increasingly difficult when multiple files are used to provide details about different features of the virtual object.

Some devices may be limited in their ability to store, render, and display virtual content, or interact with a virtual environment. In some example, these limitations may be based on device capabilities, constraints, and/or permissions.

### SUMMARY

An aspect of the disclosure provides a method for operating a digitally created collaborative environment including a plurality of user devices communicatively coupled to a network. The method can include determining, at one or more processors coupled to the network, first condition values experienced at a first user device of the plurality of user devices, each first condition value being associated with a condition of the first user device. The method can include determining first permission values for each user permission of a plurality of user permissions based on the first condition values, each user permission of the plurality of user permissions indicating a mode of operation of the user device in conjunction with the collaborative environment. The method can include selecting a first permission value of a first user permission of the plurality of user permissions. The method can include applying the first permission to the first user device.

Another aspect of the disclosure provides a non-transitory computer-readable medium comprising instructions for operating a digitally created collaborative environment including a plurality of user devices communicatively coupled to a network. When executed by one or more processors the instructions cause the one or more processors to determine first condition values experienced at a first user device of the plurality of user devices, each first condition value being associated with a condition of the first user device. The instructions further cause the one or more processors to determine first permission values for each user permission of a plurality of user permissions based on the first condition values, each user permission of the plurality of user permissions indicating a mode of operation of the user device in conjunction with the collaborative environment. The instructions further cause the one or more processors to select a first permission value of a first user permission of the plurality of user permissions. The instructions further cause the one or more processors to apply the first permission to the first user device.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a system for determining values of conditions experienced by a user, and using the values of the conditions to determine a value of a user permission to apply to the user;

FIG. 1B is a functional block diagram of another embodiment of a system for determining values of conditions experienced by a user, and using the values of the conditions to determine a value of a user permission to apply to the user;

FIG. 2A is a flowchart of a process for selecting values of user permissions to apply to a user based on conditions experienced by the user;

FIG. 2B is a table of exemplary connectivity condition values and associated device capability condition values;

FIG. 2C is a flowchart of an embodiment of a process for determining values of one or more conditions during the process of FIG. 2A;

FIG. 2D is a flowchart of an embodiment of a process for determining one or more values of a user permission during the process of FIG. 2A;

FIG. 3A is a graphical representation of a plurality of networks communicatively coupled to the mixed reality platform of FIG. 1;

FIG. 3B is a table of exemplary values for connectivity conditions and associated user permission values that can be applied to the first user, the second user, and the third user of FIG. 3A;

FIG. 4A is a graphical representation of a plurality of users and user devices communicatively coupled to the mixed reality platform of FIG. 1;

FIG. 4B is a table of exemplary values for device capability conditions and associated user permission values that can be applied to the first user, the second user, and the third user of FIG. 4A;

FIG. 5 is a graphical representation of a plurality of users and user devices communicatively coupled to a network via different connectivity levels;

FIG. 6 is a graphical depiction of changes in condition values that result in application of different user permission values over time;

FIG. 7 is a graphical depiction of different groups of users and user devices where a different user permission value is applied to each group based on different values of conditions experienced by the users or user devices of that group; and

FIG. 8 is a graphical depiction of different visual indicators that represent user permission values that apply to a first user, where the different visual indicators are displayed to other users so those users understand permissions that apply to the first user.

### DETAILED DESCRIPTION

This disclosure relates to different approaches for determining values of conditions experienced by a user, and using the values of the conditions to determine a value of a user permission to apply to the user.

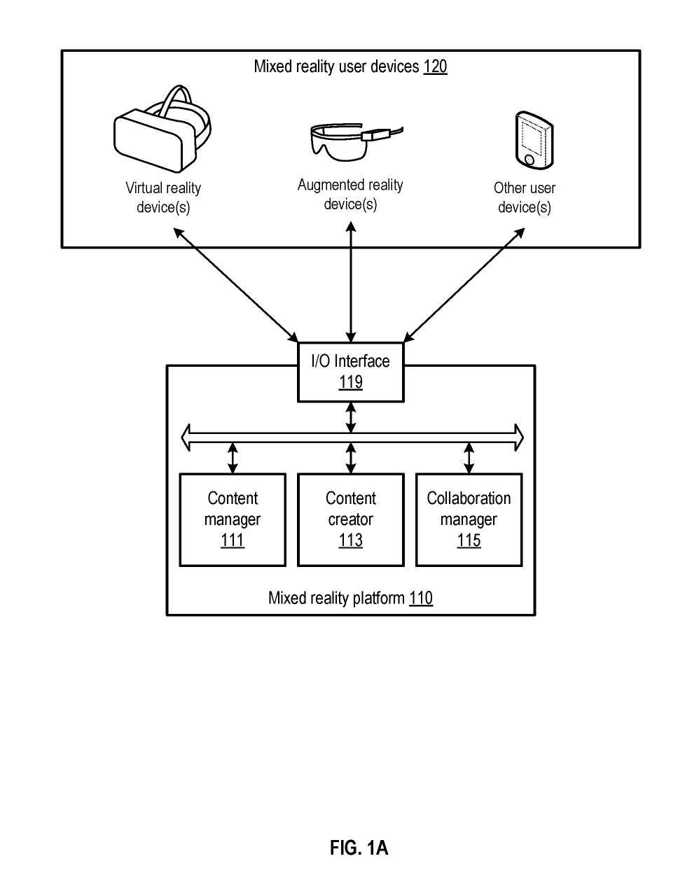

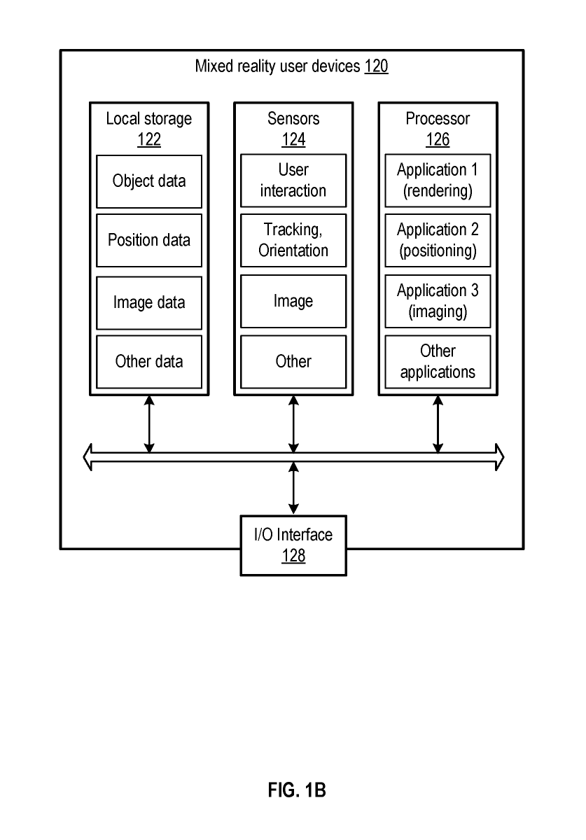

FIG. 1A and FIG. 1B depict aspects of a system on which different embodiments are implemented for determining values of conditions experienced by a user, and using the values of the conditions to determine a value of a user permission to apply to the user. The values of conditions may also be referred to herein as condition values. The values of a user permission may also be referred to herein as permission values.

A system for creating computer-generated collaborative environments and providing such collaborative environments as an immersive experience for VR, AR, and MR users is shown in FIG. 1A. In some embodiments, these collaborative environments can be implemented as virtual environments, physical environments augmented with digital or virtual content, or a combination of the two. As used herein, the term “virtual environment” can refer to a digitally created environment encompassing VR, AR, and MR environments. The “virtual environment” can include but is not isolated to only a VR environment. The system includes a mixed reality platform (platform) 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/0) interface 119. The platform can have one or more processors or microprocessors configured to perform tasks ascribed to the platform 110. The content creator 111 creates a virtual environment and visual representations of things (e.g., virtual objects and avatars) that can be displayed in a virtual environment depending on a user's point of view. This can include an AR or MR environment in which the physical world is overlaid, augmented, or otherwise supplemented with digital content. Raw data may be received from any source, and then converted to virtual representations of that data. Different versions of a virtual object may also be created and modified using the content creator 111. The content manager 113 stores content created by the content creator 111, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120.

Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device 120. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

### Determining Values of Conditions Experienced by a User, and Using the Values of the Conditions to Determine a Value of a User Permission to Apply to the User

In some systems, a user experience can be limited or at least based upon the capabilities of the user device 120. In some embodiments, the platform 110, for example, can determine, based on user device capabilities and connection whether to transmit virtual content the user device 120 for rendering at the user device 120, or whether to transmit a video stream of the virtual session. Accordingly, the disclosed systems and methods can be agnostic to the type of user device 120 being used with the platform 110. In addition, users can be made aware of limitations and/or capabilities of other users.

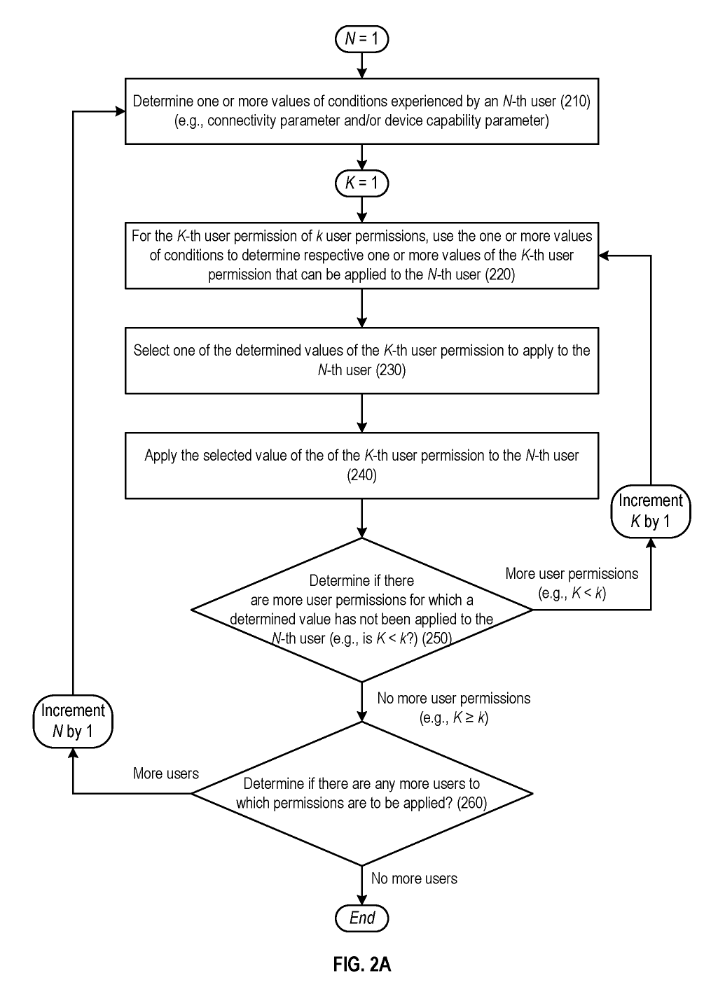

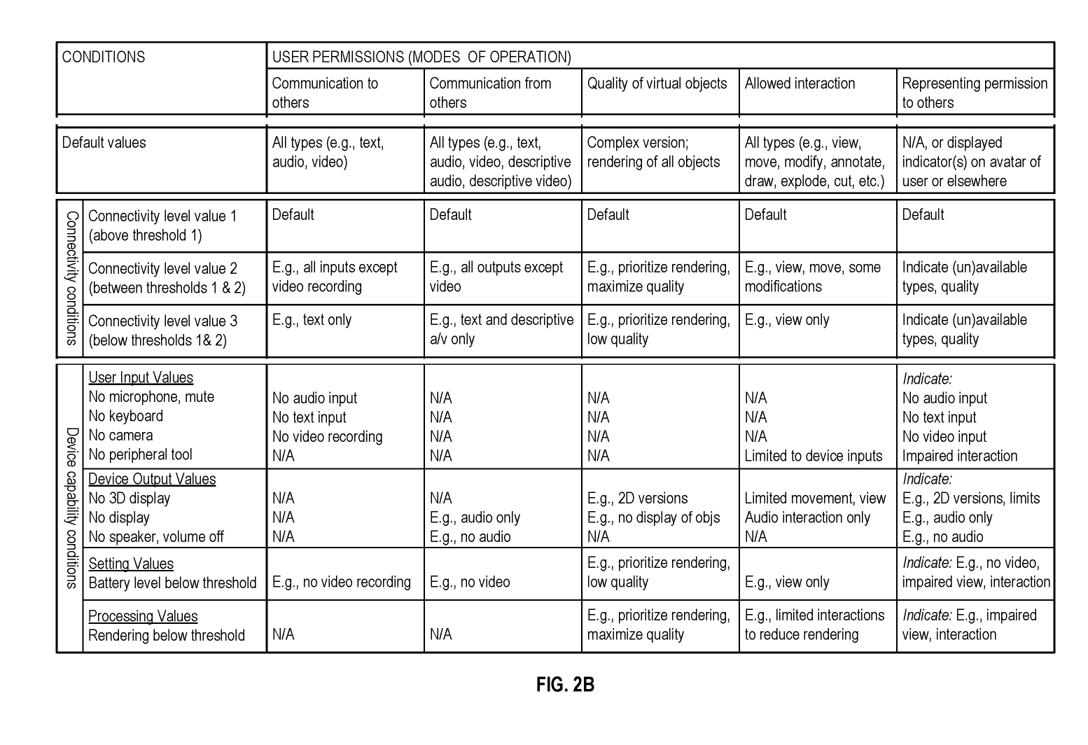

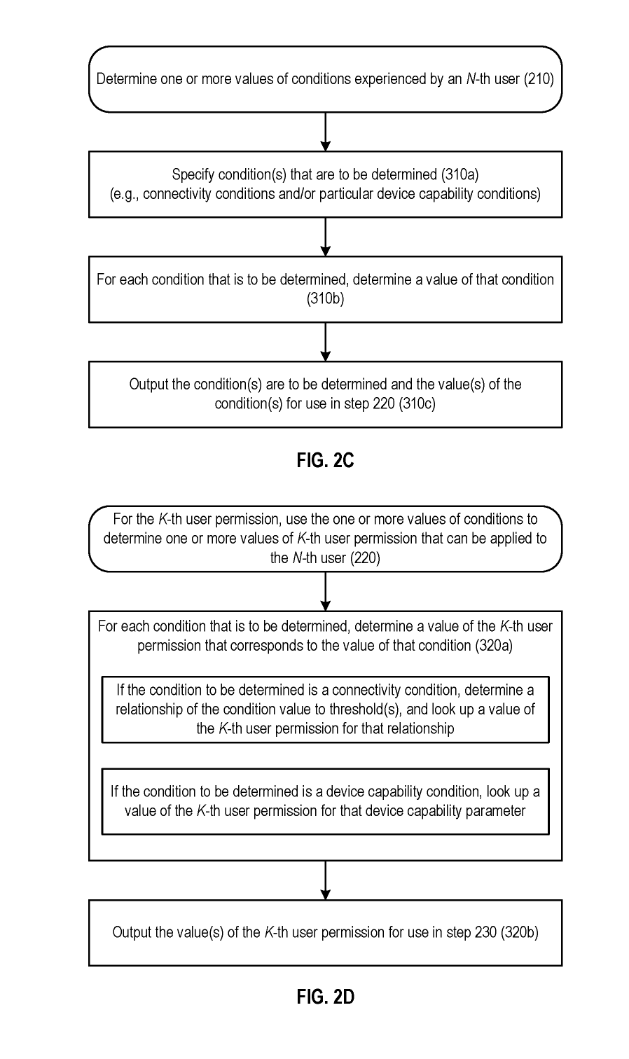

FIG. 2A is a flowchart of a process for selecting values of user permissions to apply to a user based on conditions experienced by the user.

In some embodiments, one or more values of conditions experienced by an N-th user are determined (210). The N-th user can be one of a plurality of users with a plurality of user devices 120 in a network. An illustrative process for determining values of one or more conditions during step 210 is provided in FIG. 2C, described below. Examples of conditions and associated condition values are described in connection with FIG. 2B, described below.

For a K-th user permission of k user permissions, the one or more values of conditions are used to determine respective one or more values of the K-th user permission that can be applied to the N-th user (220). An illustrative process for determining one or more values of a user permission during step 220 is provided in connection with FIG. 2D, described below. Examples of user permissions and values of user permissions are provided in connection with FIG. 2B, which is described below.

In some embodiments, one of the determined values of the K-th user permission is selected for application to the N-th user (230). By way of example, selection of a value among other values of a user permission to apply to the N-th user during step 230 may be accomplished by determining which of the values is most limiting, and then selecting a more-limiting value, or the most-limiting value.

In some other embodiments, the system can provide the optimal or best possible user experience based on conditions at the user device 120 or user device capabilities. In some cases there may be a trade-off between what the device or network connection can handle and what is best to provide to the user. In one example, a first device may be able to handle a low quality version of a virtual object. But rather than provide low quality 3D experience, a 2D video stream may provide higher resolution of the virtual object, but in two dimensions. The platform 110 can instead provide a 2D video stream of the session to view the virtual environment and all objects in higher detail than in low quality 3D. This also may be true if the server is aware that the user is participating using an AR device (e.g., with limited capabilities or capability conditions—see below) and other users are using VR. Instead of rendering lower quality content to the AR device, the system can provide a video stream of all the VR content.

The selected value of the of the K-th user permission is applied to the N-th user (240).

A determination is made as to whether there are more user permissions for which a determined value has not been applied to the N-th user (e.g., is K<k?) (250). If there are more user permissions for which a determined value has not been applied to the N-th user (e.g., is K<k), steps 220 through 250 are repeated for the other user permissions. If there are no more user permissions for which a determined value has not been applied to the N-th user (e.g., is K≥k), a determination is made as to whether there are any more users to which user permission values are to be applied (260). If there are more users, steps 210 through 260 are repeated for the other users. If there are no more users, the process ends.

FIG. 2B is a table of exemplary connectivity condition values and associated device capability condition values. As shown in FIG. 2B, conditions may include a connectivity condition with any number of two or more values (e.g., a first connectivity level value above a first threshold, a second connectivity level value below the first threshold (and optionally above a second threshold), and/or optionally a third connectivity level value below the second threshold). The values of the connectivity conditions can also be referred to as condition values.

Conditions may also or alternatively include device capability conditions including an absence of a capability (incapability). The capability conditions can have associated values, including: user input capabilities (e.g., values: no microphone is available on the device, the microphone is muted, no keyboard is available on the device, no camera is available on the device, and/or no peripheral tool is available in connection with the device); device output capabilities (e.g., values: no 3D display is available on the device, no display is available on the device, no speaker is available on the device, and/or the volume of the device is off or below a threshold level of volume required to hear audio output), setting capabilities (e.g., values: the battery level of the device is below a battery level threshold), memory capacity or capabilities (e.g., ability to store content prior to and during rendering), and processing capabilities (e.g., values: processing available for rendering is below a processing level threshold). The values of the capability conditions can also be referred to as condition values.

In some embodiments, the conditions may be automatically applied (e.g., indicated to or known by the platform 110). In some other embodiments, the conditions or the values of the conditions, such as the device capabilities, may be user-defined. User definitions through user preferences, for example, can indicate desired operating characteristics based on the external environment of the user device 120, or other factors not readily identifiable via the user device 120 itself. For example, while a user device 120 may have a microphone, the associated user may be in a public environment and may selectively indicate (or select) the inability to talk given a noisy environment or to avoid being overheard. As another example, the user device 120 may be equipped with a mouse or other pointing device, but the user may want any input to remain private and so, selectively indicate “no peripheral tool,” as in FIG. 2B. As another example, the user device 120 may have known processing deficiencies, and so the user may elect to only receive a video stream of the content as opposed to a full virtual environment. Each of these examples may necessarily limit what the user can do and how much the user can participate, in response. However, this also provides a wide range of interoperability measures allowing the system to be agnostic to the type of user device 120 and allow use of almost any user device 120 (e.g., 2D or 3D, MR, VR, AR, etc.).

In some embodiments, the platform 110 may indicate various (or all) conditions affecting a single user device to all other user devices 120. For example, if a first user device 120 lacks a keyboard (or has another capability condition) that condition or those conditions are indicated to all other user devices 120 in the network. In some other embodiments, the user devices 120 may provide certain messaging (e.g., a broadcast) that indicates any conditions (e.g., network conditions, component or equipment degradations, absence of certain components, etc.) affecting interoperability (either positive or negative) to other user devices 120 in the network. Thus, all user devices 120 in the network are aware of all other user devices' abilities to, for example, transmit or respond (e.g., by text or audio), draw, manipulate, or create content within the virtual environment, etc.

Different user permission values for each condition value are shown in the same row as that condition value in FIG. 2B. User permissions and values of those user permissions may include the following: types of communication by the user to others (values: all types of inputs (e.g., text, audio, video) by the user are allowed, all inputs except video input by the user are allowed, only text input by the user is allowed, no audio input by the user is allowed, no text input by the user is allowed, and/or no video input by the user is allowed); communication from others (values: all types of outputs (e.g., text, audio, video, text description of audio, text or audio description of video) to the user are allowed, all outputs except video output to the user are allowed, only text or text description of audio or video output to the user are allowed, only audio output to the user is allowed, no audio output to the user is allowed, and/or no video output to the user is allowed); quality of virtual objects displayed to user (values: the qualities of rendered virtual objects are complex versions of those virtual objects, the qualities of rendered virtual objects are less than the complex versions of those virtual objects but maximized to be better than lowest quality versions, the qualities of rendered virtual objects are the lowest quality versions compared to other versions, only some virtual objects are rendered based on a priority of that virtual object over other virtual object(s), virtual objects are rendered in 2D instead of 3D, and/or no virtual objects are rendered); and allowed interactions by the user within the virtual environment and with virtual objects (values: all types of interactions are allowed (e.g., view, move, modify, annotate, draw, explode, cut, others), only some interactions are allowed (e.g., view, move and some modifications); only interactions assigned to available inputs of the device are allowed; only interactions that limit rendering are allowed, such as viewing the external surfaces of a virtual object and some movements around the virtual object, but not exploding the virtual object to view inside the virtual object; some interactions are limited (e.g., allowing the user to view only a limited number of virtual objects or some of the virtual environment at a time when a 2D screen of a particular size is in use); or only one type of interaction is allowed (e.g., viewing virtual objects only, or audio/speech-recognition-initiated interactions only)).

In some embodiments, where two condition values result in a different value for the same user permission, the most-restrictive value may be selected. For example, a battery level below a battery level threshold permits all inputs except video recording by the user, and a connectivity level value 3 permits only text inputs by the user. In this case, the most limiting user permission value is associated with the connectivity level value 3, which permits only text inputs by the user. Thus, the user permission value that applies to the user/user device would be that only text inputs by the user are allowed.

Applying any user permission value can be accomplished in different ways—e.g., an application on the user device 120 can apply the user permission values, a server can apply the user permission values by sending communications to the user device that are allowed by the user permission values, or other approaches. In some other embodiments, the user can be provided various options for interaction via the user device 120, such as lower (3D) quality content versus a (2D) video stream. Such content and quality settings can be adjusted as needed at any time over the duration of the session. For example, the user may move to an area having better connectivity and therefore the “decision point” switches the user device 120 to high(er) quality output. In such embodiments, the platform 110 can periodically receive updates as to values of one or more conditions (e.g., condition values) of a given user device 120. This can allow the platform 110 to dynamically update user permissions or values of user permissions on a per-user device basis.

In some embodiments, all of the user devices 120 can be informed of other user devices' permissions. This can be accomplished via messaging from individual user devices 120 (e.g., broadcast) or from the platform 110. In some embodiments, the platform 110 can inform the network of the various user permissions and conditions ascribed to all other user devices 120.

FIG. 2C is a flowchart of a process for determining values of one or more conditions during step 210. As shown, condition(s) that are to be determined are specified (310a), where the specification of conditions is automatic, based on user input, or determined from another approach. A value of each specified condition is determined (310b)—e.g., by measuring a connectivity value using known approaches and comparing it to one or more connectivity level thresholds, by determining available user inputs, by determining available device outputs, by measuring a battery level using known approaches and comparing it to one or more battery level thresholds, and/or by determining how much processing capacity is available using known approaches and comparing it to different levels of processing required for different levels of rendering. Finally, the specified condition(s) along with the value(s) of the condition(s) are output for use in step 220 (310c).

FIG. 2D is a flowchart of a process for determining one or more values of a user permission during step 220 is provided in FIG. 2D. For each specified condition, a value of the K-th user permission that corresponds to the value of that condition is determined (320a), and the value(s) of the K-th user permission are output for use in step 230 (320b). By way of example, if the specified condition to be determined is a connectivity condition, a relationship of the condition value to threshold(s) is determined, and a value of the K-th user permission for that relationship is looked up from a storage device. By way of another example, if the condition to be determined is a device capability condition, a value of the K-th user permission for that device capability condition value is looked up from a storage device.

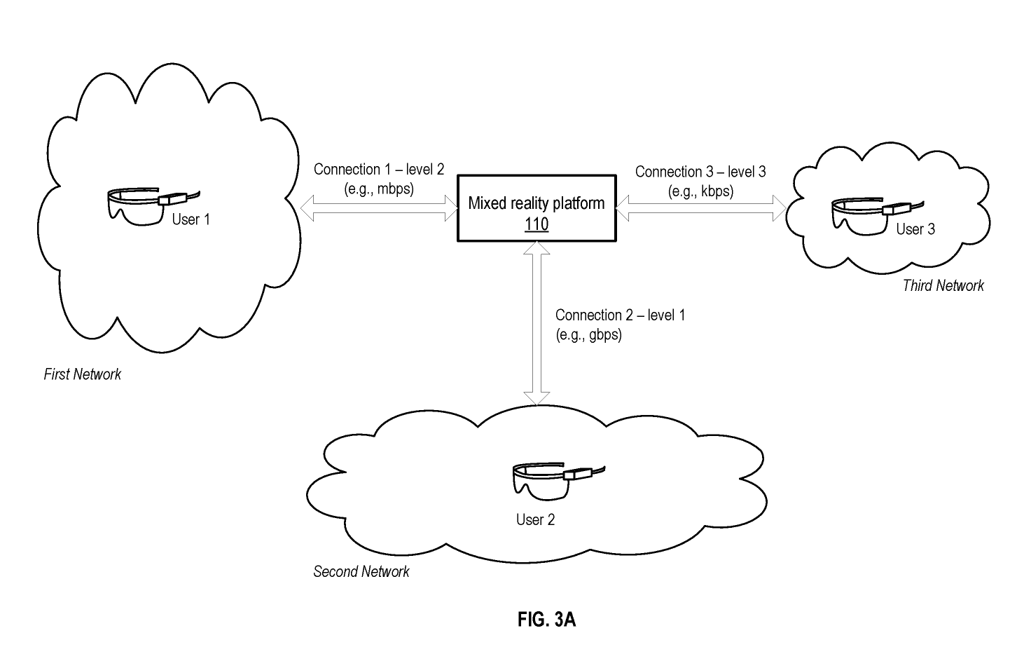

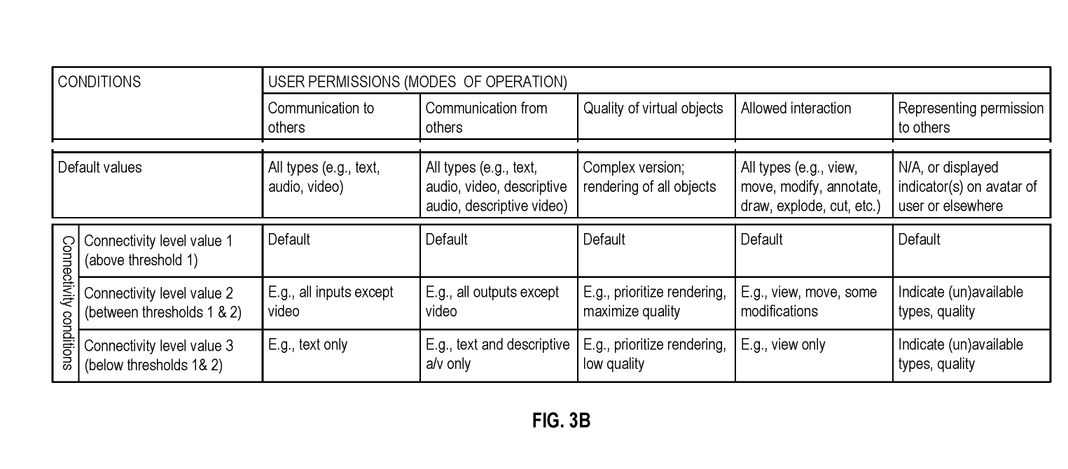

FIG. 3A is a graphical representation of a plurality of networks communicatively coupled to the mixed reality platform of FIG. 1. As shown, each network has an associated connectivity level value—e.g., the first network has a first connectivity level value of 2, the second network has a second connectivity level value of 1, and the third network has a third connectivity level value of 3. The connectivity level values may be used to look up user permission values shown in FIG. 2B, which are reproduced in FIG. 3B. Three networks are shown, but any number of networks are possible. Also, each network need not have a different connectivity level such that two networks may have the same connectivity level. Connectivity levels may include levels of throughput (e.g., kilo/mega/gigabytes per second, or another measurement) that are determined using known approaches for determining throughput. Alternatively, connection levels may include levels of latency, or another measurement of connectivity. The value of a connectivity condition is shown as a level that comprises a range of connectivity measurements. Other values of connectivity conditions are possible.

FIG. 3B is a table of exemplary values for connectivity conditions and associated user permission values that can be applied to the first user, the second user, and the third user of FIG. 3A. The table includes a subset of condition values and associated user permission values from FIG. 2B. For purposes of illustration, a first network has a first connection with a first connectivity level value of 2 that is experienced by the first user, a second network has a second connection with a second connectivity level value of 1 that is experienced by the second user, and a third network has a third connection with a third connectivity level value of 3 that is experienced by the third user. The values are provided only for illustration, and each network need not have a different connectivity level value.

By way of example, since the first user is experiencing the first connectivity level value of 2, the following user permission values apply to the first user: all inputs by the first user except video are allowed; all outputs by the device to the first user except video are allowed (e.g., such that any video output by another user is converted to descriptive audio or text at the platform 110 before the descriptive audio or text is sent to the device of the first user); rendering of virtual objects are prioritized (e.g., virtual objects in view or being interacted with by the first user or other user are rendered before other objects not in view or not being interacted with the first user or other user); the qualities of virtual objects displayed on the device of the first user is less than some versions of the virtual objects, but better than lower versions of the virtual objects; and/or interactions by the first user with virtual objects are restricted to a subset of the default types of interactions.

By way of example, since the second user is experiencing the second connectivity level value of 1, all default user permission values apply to the second user, including: all inputs by the first user are allowed; all outputs by the device to the first user are allowed; rendering of virtual objects need not be prioritized; the qualities of virtual objects displayed on the device of the first user are complex versions of the virtual objects; and/or interactions by the first user with virtual objects are not restricted.

By way of example, since the third user is experiencing the third connectivity level value of 3, the following user permission values apply to the third user: only text input by the first user is allowed; only text and descriptive text about audio or video are allowed (e.g., such that any audio or video output by another user is converted to descriptive text at the platform 110 before the descriptive text is sent to the device of the third user); rendering of virtual objects are prioritized; the qualities of virtual objects displayed on the device of the third user are the lower versions of the virtual objects; and/or interactions by the third user with virtual objects are restricted more than the first user (e.g., the third user is only allowed to view the virtual objects).

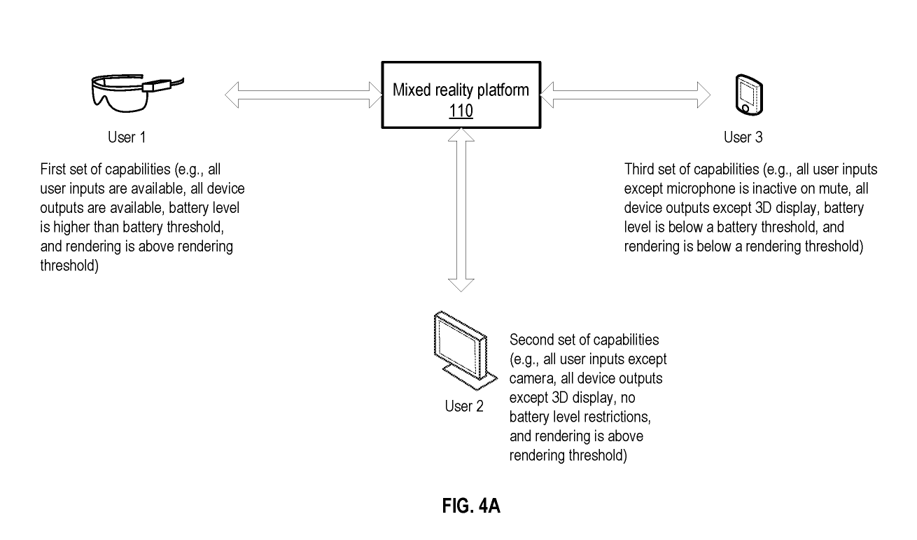

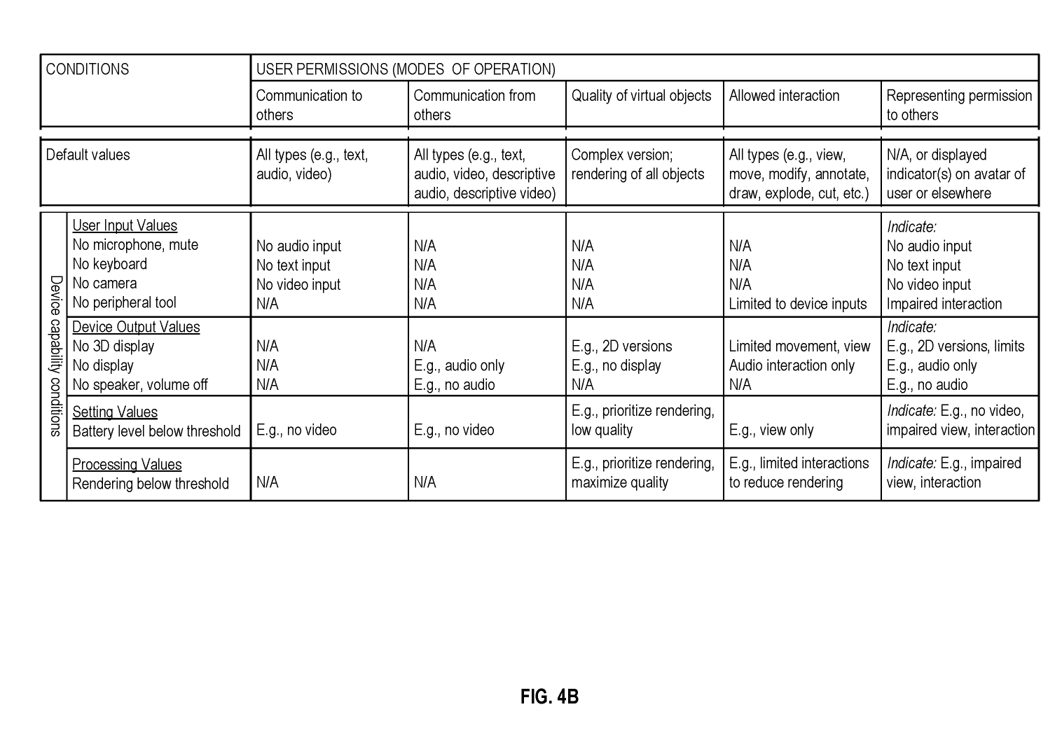

FIG. 4A is a graphical representation of a plurality of users and user devices communicatively coupled to the mixed reality platform of FIG. 1. Each of the plurality of users or user devices of FIG. 4A has a particular set of device capability value(s)—e.g., the first user operates a first user device (e.g., AR/VR headset) that has a first set of device capability values, the second user operates a second user device (e.g., desktop computer) that has a second set of device capability values, and the third user operates a third user device (e.g., mobile computing device like a smart phone) hat has a third set of device capability values. The different sets of device capability values may be used to look up associated user permission values shown in FIG. 2B, which are reproduced in FIG. 4B. Three devices are shown, but any number of devices is possible. Also, any of the devices can be on the same network or different networks. Device capabilities are determined using known approaches for determining each device capability. By way of example the first set of device capability values includes all user inputs, all device outputs, a battery level above a battery threshold (no battery level restrictions), and rendering processing above a rendering processing threshold; the second set of device capability values includes all user inputs except a camera, all device outputs except a 3D display, a battery level above a battery threshold (no battery level restrictions), and rendering above a rendering threshold; and the third set of device capability values includes all user inputs except microphone on mute, all device outputs except 3D display, battery level below a battery threshold (battery level restrictions), and rendering below a rendering threshold.

FIG. 4B is a table of exemplary values for device capability conditions and associated user permission values that can be applied to the first user, the second user, and the third user of FIG. 4A. The table includes a subset of condition values and associated user permission values from FIG. 2B.

For purposes of illustration, the device of the first user is assumed to have full capabilities (e.g., all user inputs are available, all device outputs are available, battery level is higher than battery threshold, and available processing for rendering is above a processing threshold), so the associated permission values would be default values.

By way of example, possible condition values for device capabilities of the second user's device along with associated permission values, which are enclosed in parentheses include: no camera (no video input by user); no 3D display (2D versions of virtual objects are rendered); battery level N/A (default values), and processing available for rendering above a processing threshold (default values). Selected permission values that are most-restricting would include default values except for: no video input (from no camera) as communication inputs to other users; default types of communication received from other users; virtual objects are displayed in 2D (from no 3D display); the quality of a virtual object is complex; rendering of different virtual objects need not be prioritized; and all types of interactions are permitted.

Examples of possible condition values for device capabilities of the third user's device along with associated permission values, which are enclosed in parentheses include: mute (no audio input by user); no 3D display (2D versions of virtual objects); battery level below battery threshold (no video input by user, no video from others is provided to the user, prioritize rendering, low quality of virtual objects, the only allowed interaction is viewing); processing available for rendering is below a processing threshold (prioritize rendering, maximize quality of virtual objects, interactions that minimize rendering are allowed). By way of example, selected permission values that are most-restricting would include default values except for: no audio input (from mute) and no video input (from battery level below battery threshold) as communication inputs to other users; no video (from battery level below battery threshold) as communication from other users provided to the user; virtual objects are displayed in 2D (from no 3D display), the quality of virtual objects is low (from battery level below battery threshold); rendering of different virtual objects is prioritized (from battery level below battery threshold, and from processing available for rendering below a processing threshold); and the third user can only view virtual objects (from battery level below battery threshold). If a condition value changes, such as when the battery level is charged above the battery level threshold, then the selected permission values that are most-restricting change—e.g., no audio input (from mute) as communication input to other users is still applied; video input would be available as a communication input to others; video would be available as communication received from other users; virtual objects are still displayed in 2D (from no 3D display); the quality of virtual objects is now maximized (from processing available for rendering below a processing threshold); rendering of different virtual objects is still prioritized (from processing available for rendering below a processing threshold); and more interactions are allowed beyond view only (from processing available for rendering below a processing threshold). By way of example, the additional interactions may include moving, modifying, annotating or drawing on a virtual object, but not exploding it, for example, to see its inner contents that would have to be newly rendered.

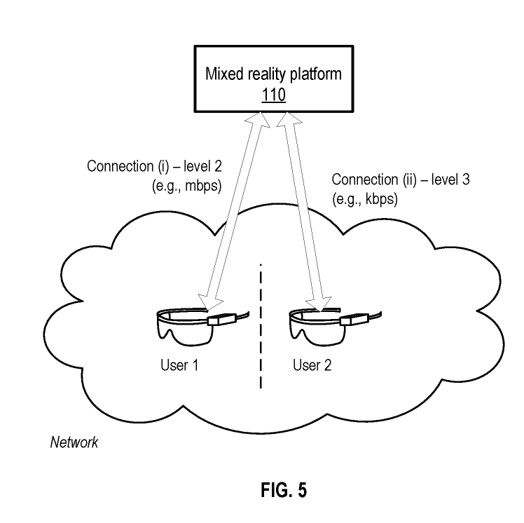

FIG. 5 is a graphical representation of a plurality of users and user devices communicatively coupled to a network via different connectivity levels. As described herein the varying connectivity levels (as user permission values) may apply to different users/devices based on user conditions. For example, a first user may be allowed a higher connectivity level compared to a second user with a lower connectivity level based on a first value of a condition for the first user that is preferred over a second value of the condition. By way of example, one condition includes any of the device capabilities (e.g., a higher connectivity level is given to the user with certain available inputs and/or certain available outputs, or a certain battery level relative to a battery level threshold, or a certain amount of processing available for rendering relative to a processing level threshold). By way of another example, another condition value is based on a user's activity in a virtual environment or interaction with a virtual object (e.g., a higher connectivity level is given to the user that is interacting with a virtual object, moving through the virtual environment, or another activity).

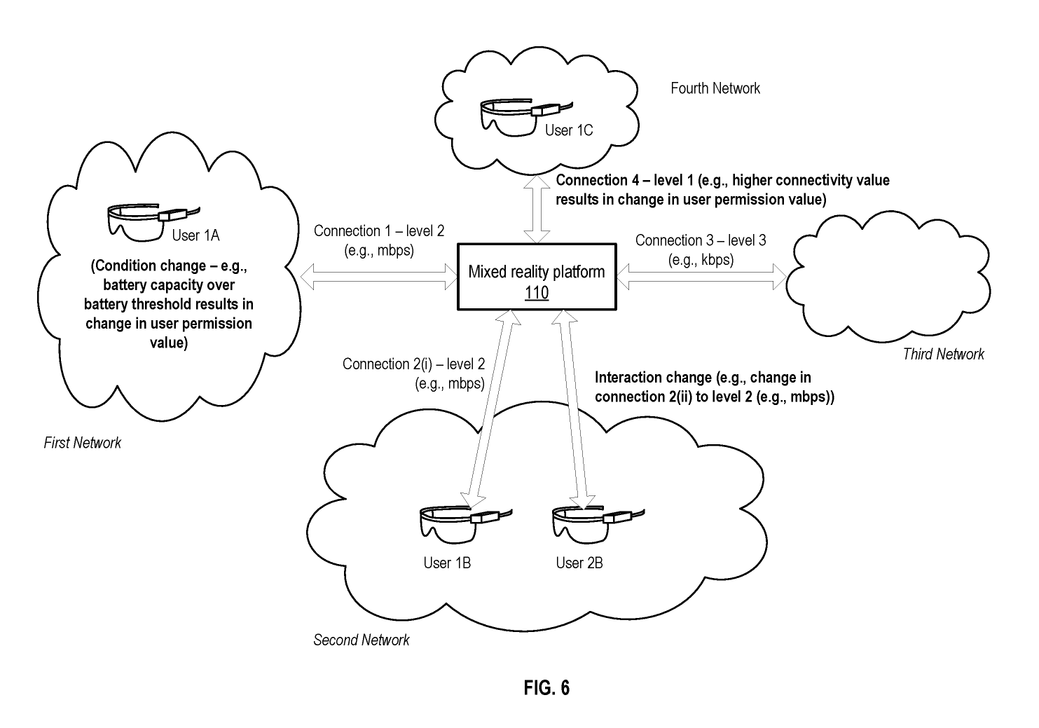

FIG. 6 is a graphical representation of changes in condition values, which may result in application of different user permission values.

As shown, a condition change for device capability (e.g., for User 1A) results in new user permission values being applied to that user. By way of example, if a device capability condition value changes from a battery level below a battery threshold to a battery level above the battery threshold, such as when a device is plugged in after previously discharging below the battery threshold, the user permission values associated with the battery level change from (i) first values (e.g., all user inputs except microphone are available, all device outputs except 3D display are available, the values associated with battery level being below a battery threshold, and the values associated with processing available for rendering being below a processing threshold) to (ii) second values (e.g., all user inputs are available, all device outputs are available, the values associated with battery level being higher than the battery threshold, and the values associated with processing available for rendering being above the processing threshold). Changes also occur as user inputs or user outputs change (e.g., a user device is unmuted making audio input available, or the volume of a user device is increased over a threshold level such that a user can hear audio outputs). The final user permission values that apply to the user may depend on values of other conditions (e.g., connectivity conditions).

By way of another example, if an interaction condition value of a user (e.g., User 2B) changes from one value (e.g., not interacting with a virtual object in a virtual environment) to another value (e.g., interacting with the virtual object in the virtual environment), the user permission values associated with the connectivity change from a first value (e.g., one connectivity level applied to the user) to a second value (e.g., a different connectivity level applied to the user). The final user permission values applied to the user may depend on values of other conditions (e.g., connectivity conditions, device capability conditions).

By way of another example, if a connectivity condition value of a user (e.g., User 1C) changes from one level (e.g., level 3) to another level (e.g., level 1), the user permission values associated with the connectivity change from first values (e.g., only text input by the user is allowed, only text and descriptive text about audio or video are provided to the user, rendering of virtual objects are prioritized, the quality of virtual objects displayed on the device of the user are the lower versions of the virtual objects, and/or interactions by the user with virtual objects are restricted) to second values (e.g., all default user permission values apply to the user). The final user permission values that apply to the user may depend on values of other conditions (e.g., device capability conditions). Such a change in network connectivity may occur on the same network (e.g., having stronger signaling after moving within a wireless network), or by switching networks.

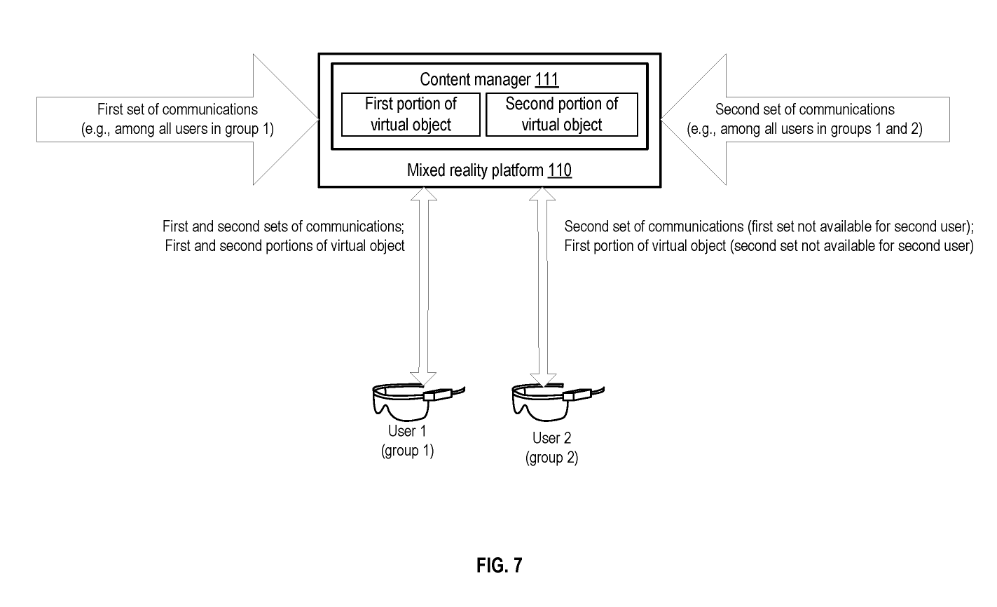

FIG. 7 is a graphical representation of different groups of users and user devices where different user permission values apply to each group based on different values of conditions experienced by the users/user devices of that group. In one embodiment, each condition value for each user is based on a security level for that user—e.g., a first user (User 1) is part of a first group (group 1) that has a first level of security, and a second user (User 2) is part of a second group (group 2) that does not have the first level of security and/or that has a second level of security—and, different user permission values (e.g., which portions of a virtual object can be seen, or which communications can be received) apply to the different users depending on the different condition values. In one implementation, the users with the first security level are able to see more portions of a virtual object (e.g., first and second portions) than the users without the first security level (e.g., who cannot see the second portion of the virtual object, which may be designated for restricted viewing to only certain users). In another implementation, the users with the first security level are able to receive more communications (e.g., first and second sets of communications) than the users without the first security level (e.g., who cannot receive the first set of communications created by users in the first group). Other ways to group users other than using security levels are contemplated, including user-designated groups, preset groups within an organization, or other ways of forming groups.

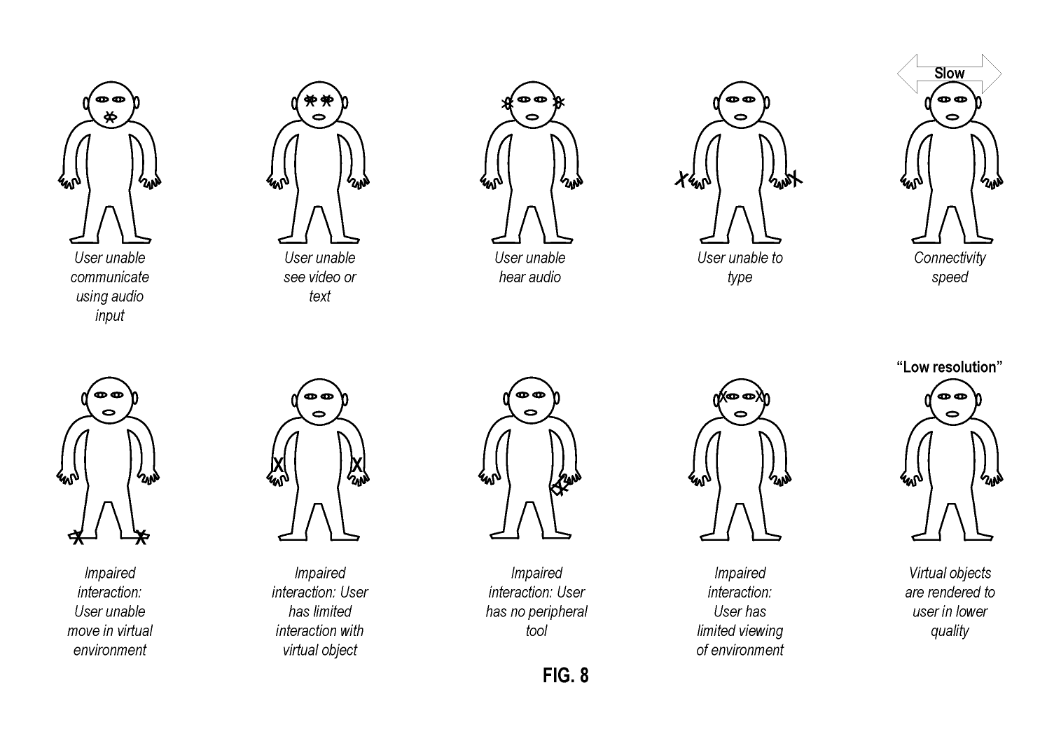

FIG. 8 is a graphical representation of different visual indicators that represent user permission values that apply to a first user, where the different visual indicators are displayed to other users. Different indicators are provided with an avatar of the first user, which may be seen by the other users when the other users view a virtual environment that contains the avatar. The indicators may be viewed by the other users so those other users are aware of the user permissions that apply to the first user. The indicators can take other forms than the forms shown in FIG. 8 so long as those other forms indicate the specified user permissions that apply to the first user. Instead of indicating what the user is unable to do, the indicators can illustrate what the user is able to do—e.g., a keyboard indicating user is only able to input text or read text. Indicators need not be shown on an avatar, and may be shown elsewhere.

User permissions can alternatively be considered as user modes of operation.

### Other Aspects

Methods of this disclosure may be implemented by hardware, firmware or software. For example, one or more non-transitory machine-readable media embodying program instructions that, when executed by one or more machines (e.g. processors of the platform 110), cause the one or more machines to perform or implement operations comprising the steps of any of the methods or operations described herein can be used. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for operating a digitally created collaborative environment including a plurality of user devices communicatively coupled to a network, the method comprising:
determining, at one or more processors coupled to the network, first condition values experienced at a first user device of the plurality of user devices, each first condition value being associated with a condition of the first user device;
determining first permission values for each user permission of a plurality of user permissions based on the first condition values, each user permission of the plurality of user permissions indicating a mode of operation of the user device in conjunction with the collaborative environment;
selecting a first permission value of a first user permission of the plurality of user permissions; and
applying the first permission to the first user device.

2. The method of claim 1 further comprising:
determining, at the one or more processors, second condition values experienced at a second user device of the plurality of user devices;
determining second permission values for each user permission based on the second condition values;
selecting a second permission value of a second user permission of the plurality of user permissions; and
applying the second permission to the second user device.

3. The method of claim 2 further comprising:
indicating the first condition values and the first permission values to the second user device; and
indicating the second condition values and the second permission values to the first user device.

4. The method of claim 3 further comprising, indicating on a first avatar associated with the first user device in the collaborative environment and a second avatar associated with the second user device in the collaborative environment, one or more visual indicators viewable by the plurality of user devices, the visual indicators indicating user permissions that apply respectively to the first user device and the second user device.

5. The method of claim 1 further comprising:
determining changes in one of the first condition values and the second condition values; and
updating the first permission values and the second permission values based on the changes.

6. The method of claim 1 further comprising receiving, at the one or more processors, an indication of conditions experienced at the first user device, the indication being based on one of user preferences, device capabilities, and network connectivity.

7. The method of claim 1, wherein the plurality of conditions comprise connectivity conditions and device capability conditions.

8. The method of claim 7, wherein the connectivity conditions indicate a state of network connectivity with respect to a threshold level of connectivity.

9. The method of claim 7, wherein the device capability conditions indicate a presence or absence of one or more user device components that affect interoperability of the first user device within the collaborative environment.

10. A non-transitory computer-readable medium comprising instructions for operating a digitally created collaborative environment including a plurality of user devices communicatively coupled to a network, that when executed by one or more processors cause the one or more processors to:
determine first condition values experienced at a first user device of the plurality of user devices, each first condition value being associated with a condition of the first user device;
determine first permission values for each user permission of a plurality of user permissions based on the first condition values, each user permission of the plurality of user permissions indicating a mode of operation of the user device in conjunction with the collaborative environment;
select a first permission value of a first user permission of the plurality of user permissions; and
apply the first permission to the first user device.

11. The non-transitory computer-readable medium of claim 10 further comprising instructions to cause the one or more processors to:
determine second condition values experienced at a second user device of the plurality of user devices;
determine second permission values for each user permission based on the second condition values;
select a second permission value of a second user permission of the plurality of user permissions; and
apply the second permission to the second user device.

12. The non-transitory computer-readable medium of claim 11 further comprising instructions to cause the one or more processors to:
indicating the first condition values and the first permission values to the second user device; and
indicating the second condition values and the second permission values to the first user device.

13. The non-transitory computer-readable medium of claim 12 further comprising, indicating on a first avatar associated with the first user device in the collaborative environment and a second avatar associated with the second user device in the collaborative environment, one or more visual indicators viewable by the plurality of user devices, the visual indicators indicating user permissions that apply respectively to the first user device and the second user device.

14. The non-transitory computer-readable medium of claim 10 further comprising instructions to cause the one or more processors to:
determine changes in one of the first condition values and the second condition values; and
update the first permission values and the second permission values based on the changes.

15. The non-transitory computer-readable medium of claim 10 further comprising instructions to cause the one or more processors to receive an indication of conditions experienced at the first user device, the indication being based on one of user preferences, device capabilities, and network connectivity.

16. The non-transitory computer-readable medium of claim 10, wherein the plurality of conditions comprise connectivity conditions and device capability conditions.

17. The non-transitory computer-readable medium of claim 16, wherein the connectivity conditions indicate a state of network connectivity with respect to a threshold level of connectivity.

18. The non-transitory computer-readable medium of claim 16, wherein the device capability conditions indicate a presence or absence of one or more user device components that affect interoperability of the first user device within the collaborative environment.
